(19) United States
(12) Patent Application Publication
(10) Pub. No.: US 2011/0161597 A1
(43) Pub. Date: Jun. 30, 2011

(54) Combined Memory Including a Logical Partition in a Storage Memory Accessed Through an IO Controller

(75) Inventors: Robert B. Tremaine, Stormville, NY (US); Robert W. Wisniewski, Ossining, NY (US)

(73) Assignee: INTERNATIONAL BUSINESS MACHINES CORPORATION, Armonk, NY (US)

(21) Appl. No.: 12/649,856

(22) Filed: Dec. 30, 2009

(51) Int. Cl. G06F 12/08; G06F 12/00

(52) U.S. Cl. 711/133; 711/154; 711/118; 711/E12.001; 711/E12.022

(57) ABSTRACT

A computer system having a combined memory. A first logical partition of the combined memory is a main memory region in a storage memory. A second logical partition of the combined memory is a direct memory region in a main memory. A memory controller comprising a storage controller is configured to receive a memory access request including a real address from a processor, determine whether the real address is for the first logical partition or for the second logical partition. If the address is for the first logical partition the storage controller communicates with an IO controller in the storage memory to service the memory access request. If the address is for the direct memory region, the memory controller services the memory access request in a conventional manner.

### FIELD OF THE INVENTION

This invention relates generally to memory, storage, and cache in electronic systems, in particular computer systems having a large amount of memory.

### SUMMARY OF EMBODIMENTS OF THE INVENTION

Embodiments of the invention include methods and apparatus for a combined memory having a storage memory comprising a main memory region that is a first logical partition of the combined memory. The storage memory is coupled by an IO controller to a memory controller. The storage memory may further comprise a storage region implemented with hard disks or hard disk equivalent. The combined memory further comprises a main memory, the main memory further comprising a direct memory region that is a second logical partition of the combined memory. The memory controller, further comprising a storage controller, is configured to access the main memory region for accesses using addresses that are mapped to the main memory region, and to access the direct memory region using addresses that are mapped to the direct memory region. The storage controller communicates with the IO controller using a suitable protocol to transmit data in either direction.

In an embodiment of the invention, the main memory may be partitioned into the direct memory region and a cache region. The cache region is configured to hold cache blocks read from the main memory region. The main memory may further contain a directory region to hold directory entries associated with cache blocks in the cache region. In an alternative embodiment, the directory region may be placed in the memory controller.

In various embodiments, space allocated in the main memory to the direct memory region, the cache region, and the directory region is programmable. In an embodiment the cache block size is programmable.

### BRIEF DESCRIPTION OF THE DRAWINGS

FIG. 1 is a block diagram of a computer system having a combined memory comprising a first logical partition of which is in a storage memory. A second logical partition is in a main memory.

FIG. 2 is a diagram depicting how a main memory may be portioned into a directory region, a cache region and a direct memory region. The cache region is configured to store cache blocks read from a main memory region in the storage memory.

FIG. 3 shows an alternate embodiment of a memory controller and a main memory in which a directory region is physically in the memory controller instead of being a partition in the main memory.

FIG. 4 shows a combined memory comprising a first logical partition physically in main memory and a second logical partition physically in storage memory.

FIG. 5 shows a memory controller coupled to a processor by a processor bus; to a main memory by a memory bus; and to a storage memory by a storage bus.

FIG. 6 shows a configuration registers block, comprising registers that may be programmed to determine size and placement of main memory regions in storage memory, and size and placement of a direct memory region, a cache region and a directory region in main memory. A cache block size may determine size of cache blocks used.

FIG. 7 shows an exemplary cache data entry that may be stored in the directory region.

FIG. 8 shows a flow chart of a method embodiment of the invention.

FIG. 9 shows a flow chart of location data associated with a memory request being transmitted back to a processor such that software will know what type of storage is associated with an address in the memory request.

FIG. 10 shows addition details of a memory descriptor table.

### DETAILED DESCRIPTION OF THE EMBODIMENTS

In the following detailed description of embodiments of the invention, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

Embodiments of the present invention provide for reducing power, reducing cost, and increasing storage density (e.g., bits per cubic centimeter) in a computer system.

Computer main memory systems are architected and designed to provide the most cost effective memory, typically, in current technology, SDRAM (Synchronous Dynamic Random Access Memory), in an affordable packaging volume close to one or more processors in a computer system. This volume varies in dimension and physical packaging technology by class and type of computing system, limiting the number of main memory devices that can be used and affording tens of gigabytes (GB) of main memory. Packaging low cost (higher density) memory technologies in a memory volume displaces the higher performance conventional SDRAM, reducing the effective performance or increasing the power consumption.

Computer storage systems are increasingly employing high density memory technologies in place of rotational storage technologies (e.g., hard disks) to benefit from such high density memory technologies. These applications of high density memory technologies are easily packaged in the relatively large and expandable volumes in mass storage areas (such has hard disks or solid state equivalents) within the computing system. However access is restricted to and by software and granularity precludes operating this storage as main memory. Moreover, storage memory access latency is an order of magnitude higher than that of main memory.

Embodiments of the invention provide for logically allocating a main memory region within the storage memory, and servicing memory accesses to a combined memory (a direct memory region in the main memory plus the main memory region in the storage memory) without a need for software intervention. The combined memory, comprising a direct memory region in a main memory plus a main memory region in storage memory increases an effective amount of main memory known to operating system software. A memory controller is expanded to include a cache controller and a storage access controller. Main memory may be partitioned logically into a direct access region, a cache region, and a cache directory region. Details of this structure are discussed in detail below.

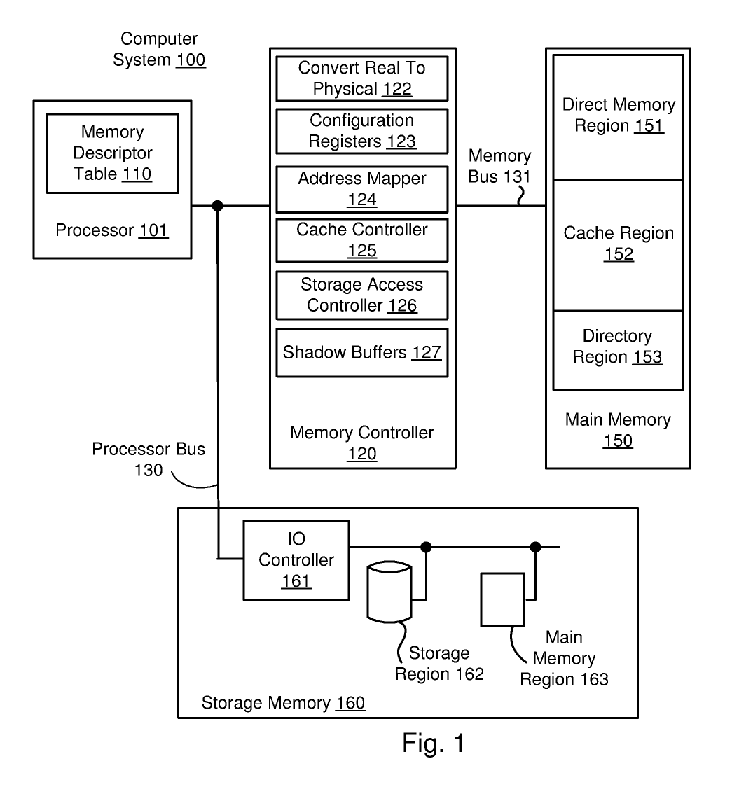

Turning now to FIG. 1, an exemplary computer system 100 is shown. Computer system 100 comprises a processor 101 that, when operating, transmits memory access requests on a processor bus 130 to a memory controller 120. Processor bus 130 also transfers data from processor 101 to memory controller when the memory access request is a write, and transfers data from memory controller 120 to processor 101 responsive to a read access request. In an embodiment, processor 101 comprises a memory descriptor table 110 that will be described in detail later.

It is understood that there may be a plurality of processors 101 coupled to processor bus 130.

Processor bus 130 may be any interconnection, electrical or optical, that can be used to transfer memory requests and data from processor 101 to memory controller 120 and transfer requested data from memory controller 120 to processor 101.

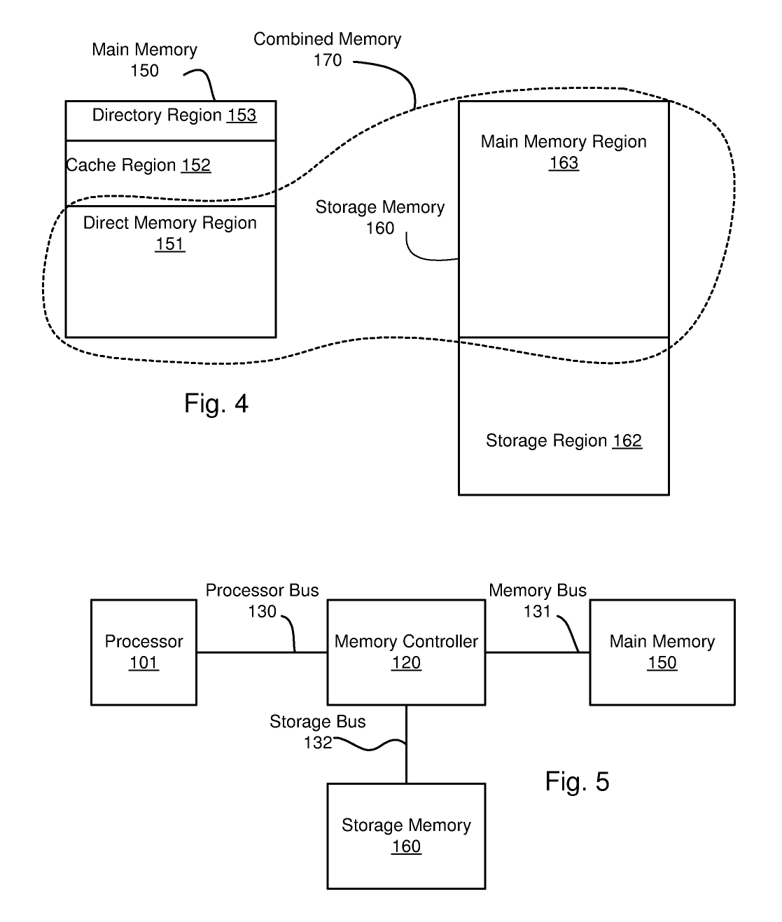

Processor bus 130, in an embodiment, is further coupled to a storage memory 160. Storage memory 160 comprises an IO controller 161, a storage region 162 to store data in a conventional manner such as, for examples, hard disks or a flash memory that is accessed as a hard disk equivalent. Storage memory 160 further comprises a main memory region 163 that stores data in main memory region 163 that is in the combined memory region 170 as generally encircled with a dotted line in FIG. 4. In another embodiment, memory controller 120 may be coupled to storage memory 160 through a separate storage bus, such as storage bus 132, shown in FIG. 5, rather than processor bus 130 in order to reduce traffic on processor bus 130, and to simplify net topology on processor bus 130, but at the expense of adding additional signal pins on memory controller 120.

Memory controller 120 is coupled by a memory bus 131 to a main memory 150. Main memory 150 comprises relatively fast, relatively power consuming, relatively low density (“relatively” compared to memory technology used in main memory region 163). Currently main memory 150 is typically implemented with SDRAM. Main memory region 163 may be implemented with denser, although slower, technologies, such as flash memory, MRAM (Magnetic Random Access Memory) technology, FeRAM (Ferroelectric Random Access Memory), or similar current or future very dense technologies. Memory controller 12 may further comprise a convert real to physical 122; a configuration registers 123; an address mapper 124; a cache controller 125; a storage access 126; and shadow buffers 127.

Main memory 150 may be partitioned into a direct memory region 151, a cache region 152, and a directory region 153 as shown in FIG. 1.

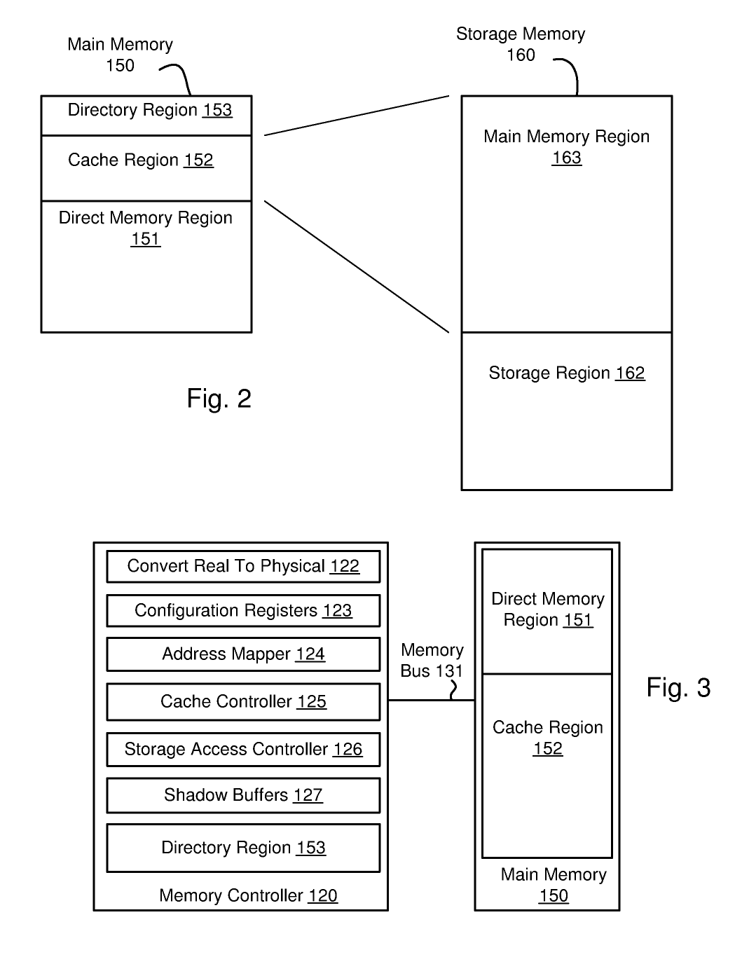

Referring now to FIGS. 1 and 2, direct memory region 151 is conventional memory, implemented in (currently) SDRAM and addressable by processor 101 through memory controller 120 in main memory 150. Direct memory region 151 is accessed by memory controller 120 in a conventional manner if a memory request from the processor is for an address determined by address mapper 124 to be in direct memory region 151.

Cache region 152 (shown in FIGS. 1 and 2) is a portion of main memory 150 configured to act as a cache for data stored in main memory region 163 in storage memory 160. Data stored in main memory region 163 may be accessed as cache blocks.

Directory region 153 contains directory information associated with cache blocks in cache region 152, for example, one or more directory entries, each directory entry comprising tag and state information associated with corresponding cache blocks in cache region 152.

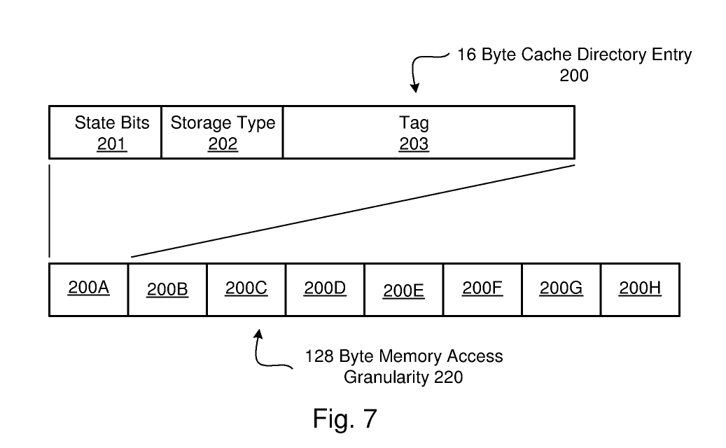

Cache region 152 and directory region 153 are used to mitigate the relatively long latency to main memory region 163, such that access requests to addresses mapped by address mapper 124 in memory controller 120 to main memory region 163 are serviced (read or write) by data in cache region 152 when the requested data exists in a cache block in cache region 152. Cache region 152 and directory region 153 may be organized as a direct map cache or as a set associative cache. In a direct mapped cache, a particular address results in a single directory entry being used from directory region 153, with a compare of appropriate bits in the particular address against a tag stored in the directory entry. Note that, as described later with reference to FIG. 7, a plurality of directory entries may be read at once, because main memory 150 is typically read at a processor granularity large enough that the plurality of directory entries are returned at once. In a set associative cache, a plurality of directory entries are read simultaneously from directory region 153, with compares being made of the particular address against tags in the plurality of directory entries in a congruence class referenced.

Cache entries in directory region 153 may comprise state information comprising, for example, valid, modified, block sector modified, and, in the case where a set associative cache is implemented, replacement weighting information.

FIG. 7 shows an exemplary cache directory entry 200 further comprising state bits 201, storage type 202 (to be described later), and tag 203. It is also shown in FIG. 7 that there may be a plurality of cache directory entries 200 fetched in parallel from cache region 152. Main memory 150 is accessed in “chunks” of data according to processor memory granularity, typically 32 to 128 bytes. In FIG. 7, for exemplary purposes, a cache directory entry is shown as being sixteen bytes, and a processor memory granularity is shown as being 128 bytes. Sizes of cache directory entries and processor memory granularity may vary widely and the values used here are understood to be for exemplary purposes only. In FIG. 7, eight cache directory entries 200 are fetched in a single 128 byte memory access. Having multiple cache directory entries 200 fetched in parallel is especially useful when a set associative cache is used.

A true (e.g., “1”) in the valid bit in a cache directory entry state information field in state bits 201 indicates that the cache block is valid and may be used to service processor read or write requests; a “0” indicates that the cache block is invalid and must not be used to service processor read/write requests.

Modified (e.g., “1” in the modified) means that the cache block has been modified; that is, data in the associated cache block has been modified since the associated cache block was read from main memory region 163. If the associated cache block is modified, and must be cast out, the associated cache block must be written back to main memory region 163. If the associated cache block has not been modified, the associated cache block need not be written back to main memory region 163.

Cache sectoring reduces a cache miss penalty, in particular when cache blocks are large. In cache sectoring, cache blocks are divided into sectors, and one or more state bits in state bits 201 may contain information regarding states of each of the sectors. When a processor requests data that is in a sector in a cache block, only the sector containing the requested data item is transmitted to the processor. In sectored caches, each directory entry maintains a “presence” bit per sector in the cache block. Presence bits are used to indicate which of the sectors in a cache block are present in the cache. Sectoring enables maintaining a small directory with a large line size without increasing the cache miss penalty.

U.S. Pat. No. 6,339,813, assigned to the present assignee, teaches of cache block sectoring, shadow buffers (also described later herein) and managing large cache blocks.

Block sector modified, as taught in U.S. Pat. No. 7,526,610, assigned to the present assignee, teaches of a memory cache comprising a data sector having a sector ID wherein the data sector stores a data entry, a primary directory having a primary directory entry, wherein a position of the primary directory entry is defined by a congruence class value and a way value and a secondary directory corresponding to the data sector having a secondary directory entry corresponding to the data sector, wherein the secondary directory entry includes a primary ID field corresponding to the way value and a sector ID field operative to identify the sector ID. In an embodiment of the invention, when replacing a cache block, state bits indicating cache sector states are examined, and only sectors that have been modified are written back to main memory region 163. Many technologies used to implement main memory region 163, such as flash memory, have a large but limited number of writes that can be made before wear out mechanisms begin to make affected locations unusable. By writing only modified sectors, time to wear out may be extended.

Replacement weighting information, using one or more particular state bits in state bits 201, may be used, as taught in US20040083341 A1, to select a line to replace in an inclusive set-associative cache memory system which is based on a least recently used (LRU) replacement policy but is enhanced to detect and give special treatment to the reloading of a line that has been recently cast out. A line which has been reloaded after having been recently cast out is assigned a special encoding which temporarily gives priority to the line in the cache so that it will not be selected for replacement in the usual LRU replacement process. This method of line selection for replacement improves system performance by providing better hit rates in the cache hierarchy levels by ensuring that heavily used lines in a cache nearer the processor are not aged out of the cache. For example, if a particular cache block in cache region 152 has not been accessed for some time by processor 101, an LRU scheme used by cache controller 125 (FIG. 1) may choose to evict the particular cache block when another cache block is needed to be loaded from main memory region 163. However, processor 101 may be heavily using data in the cache block in a processor cache (not shown) local to processor 101. Eviction of the particular cache block involves also evicting a processor cache line, in the processor cache, that is part of the cache block. A processor cache line is smaller than the cache block. The processor cache line is typically 32 to 128 bytes. If the cache block is evicted, (simply overwritten with another cache block if unmodified, or written back to main memory region 163 if modified), processor 101 will soon again want the data, causing the cache block to be re-accessed from main memory region 163. US20040083341A1's teaching is to weight the cache block in the LRU algorithm, so that, for a specified number of accesses to the associated congruence class, the cache block will not again be marked invalid or evicted from cache region 152.

A particular state bit in state bits 201 may be used to “pin” the associated cache block in cache region 152 so that the cache block is not selected by a particular cache replacement scheme such as LRU (Least Recently Used) to cast out the cache block. Of course, such “pinning” is only applicable to a set associative cache.

Addresses mapped by address mapper 124 in memory controller 120 to direct memory region 151 are serviced in a conventional manner.

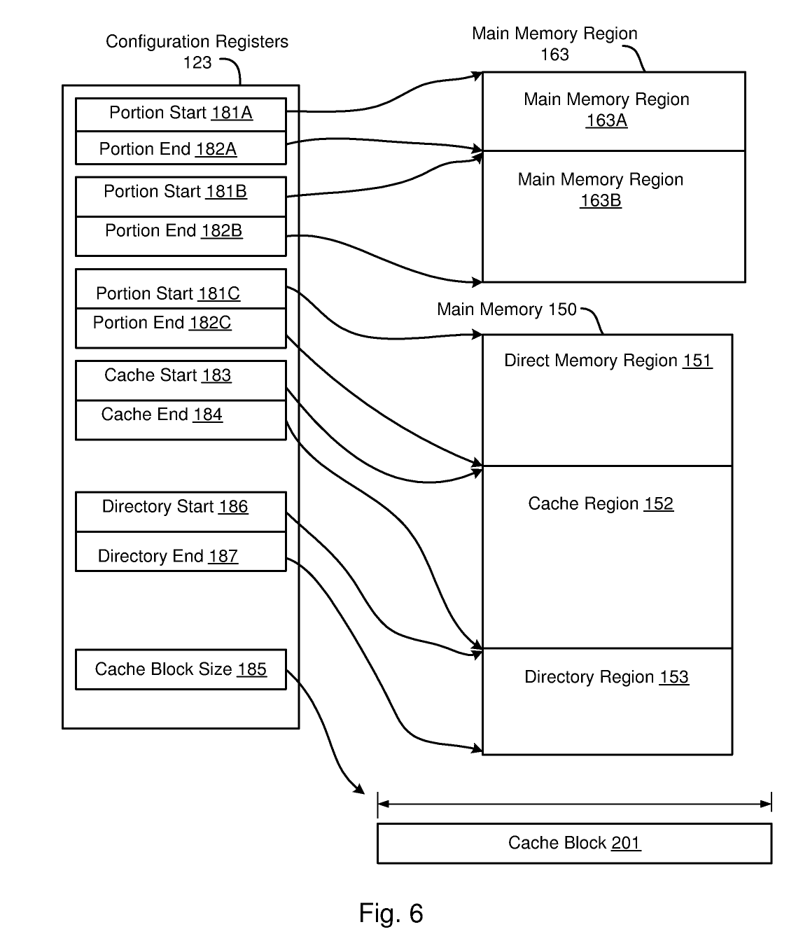

Typical cache block sizes range from 1 KB (Kilobyte) to 8 KB, although larger or smaller cache block sizes are contemplated. In an embodiment, cache block size is programmable using information stored in cache block size 185 (FIG. 6) in configuration registers 123. In FIG. 6, cache block size 185 is shown to specify size (number of bytes, for example) of cache block 201. In general, cache blocks, for simplicity, are not reference numeralled herein; however, cache block 201 is referenced in FIG. 6 to explicitly show that cache block size 185 determines size of cache blocks, cache block 201 simply showing an explicit cache block. For example, cache block size 185 may, during operation, hold a value ranging from ‘0000’ to ‘1111’, where ‘0000’ indicates that 512 byte cache blocks are being used, and ‘1111’ indicates that 8192 byte (8 KB) cache blocks are being used. Other, or additional, cache block sizes are contemplated, with a 512 byte to 8192 byte cache block size range used only for exemplary purposes. Cache controller 125 (FIG. 1), in embodiments wherein cache block size is programmable, manages cache directory tags and tag compares accordingly. That is, tag lengths when 8 KB cache blocks are used will be shorter than tag lengths when 512 byte cache blocks are used, total addressability being equal.

Convert real to physical 122 (FIG. 1) in memory controller 120 converts a real address in an access request from processor 101 to a physical address that memory controller 120 uses to access data.

Address mapper 124 in memory controller 120 (FIG. 1) directs memory accesses to direct memory region 151 or to main memory region 163. Address mapper 124 may use values stored in configuration registers 123 to determine to where a particular address is directed. For example, in an embodiment, (FIG. 6) configuration registers 123 comprise one or more of portion start 181 (181A, 181B, 181C) and one or more of portion end 182 (182A, 182B, 182C). In the exemplary FIG. 6, main memory region 163 (FIG. 2) is shown to further comprise two main memory regions 163A and 163B. Portion start 181A is a first address of main memory region 163A; portion end 182A is a last address of main memory region 163A. Portion start 181B is a first address of main memory region 163B; portion end 182B is a last address of main memory region 163B. Portion start 181C is a first address of direct memory region 151; portion end 182C is a last address of direct memory region 151. Presented with an address in a request from processor 101, address mapper 124 compares the address, in parallel or sequentially, with address ranges defined by portion starts 181 and portion ends 182 to determine whether the address is in direct memory region 151 or is in main memory region 163 (and, if so, in which sub-portion of main memory region 163.

In an embodiment, sizes of directory region 153, cache region 152, and direct memory region 151 in main memory 150 are configurable, using information hard-wired or programmed into configuration registers 123 in memory controller 120. FIG. 6 shows cache start 183 and cache end 184 which determine a starting and ending address for cache data stored in cache region 152. Directory start 186 and directory end 187 determine a starting and ending address for directory region 153. As described above, portion start 181C and portion end 182C may determine location and size of memory region 151.

In a first computer system 100, configuration registers 123 (cache start 183 and cache start 184) may be programmed to configure directory region 153 and cache region 152 to be “zero” bytes, thereby devoting all memory in main memory 150 to direct memory region 151. A second computer system may be used for queries into a vast database, requiring an enormous amount of storage. A system administrator may consider access characteristics of all or part of the vast database and accordingly program cache start 183 and cache end 184. For example, if accesses into the database tend to be fairly random, a large amount of space may be provided as main memory region 163 in storage memory 160, but a relatively small cache region 152 may be configured, since the random accessing makes it unlikely that a particular cache block that has been moved from main memory region 163 to cache region 152 is going to be used for a long period of time. If, on the other hand, the system administrator knows that data, once accessed, is likely to be needed for significant periods of time, along with other similar data, cache region 152 may be made larger so that data is more likely to still be in cache region 152 when subsequently needed after a first reference.

In an embodiment shown in FIG. 3, directory region 153 is stored in memory controller 120, for example, in SRAM (static random access memory) or eDRAM (embedded dynamic random access memory). Whereas cache region 152 may be quite large in some configurations, directory region 153 may be considerably smaller, and may be of a size that can be economically placed in memory controller 120. A directory region 153 physically placed in memory controller 120 reduces traffic on memory bus 131.

In an embodiment where the cache is direct mapped, when address mapper 124 determines that, for a read access, data resides in main memory region 163 (i.e., not in direct memory region 151), cache controller 125 accesses directory region 153 and also speculatively accesses the data in cache region 152. Data read in such a speculative read access may then be transmitted to processor 101 if cache controller 125 determines that the corresponding entry in directory region 153 indicates that the data is valid and that the tag indicates a cache “hit”. The directory entry is updated as required (e.g., if the processor then modifies the data). When the cache block is not valid or does not exist in cache region 152, a request is issued to a storage access controller 126 to form and send a read request to IO controller 161 using addressing and protocol suitable for IO controller 161. For example, storage access controller 126 may access main memory region 163 through IO controller 161 via DMA (Direct Memory Access) protocol to move the cache blocks between main memory region 163 and cache region 152. Other protocols are contemplated, including building IO protocol packets to directly access main memory region 163 with block and sector parameters.

If a valid, modified cache block must be cast out to main memory region 163 to make room for a requested cache block, storage access controller 126 must also transmit that valid, modified cache block to main memory region 163, using addressing and protocol suitable for IO controller 161 prior to reception of the requested cache block. When requested data is received it is forwarded to satisfy an initial memory request and is stored as a cache block in cache region 152 in, e.g., 128 byte increments (depending on width of processor bus 130 and, perhaps, processor cache line size requirements) as it is received. After the cache block is completely stored, the associated cache directory entry is stored in directory region 153. In this embodiment, shadow buffers 127 are used to hold cache directory entries for processor cache lines in the cache block until the cache block is completely stored. This avoids re-referencing the directory entries in directory region 153 during the reception of the cache block, which may take a significant amount of time, in particular when large cache blocks are used.

In an embodiment, main memory region 163 (FIG. 1) comprises non-volatile memory technology, such as flash memory. Memory controller 120 is configured to store all or part of main memory 150 contents in main memory region 163 to save power or support fast restart after a power loss or during maintenance on main memory 150.

For example, a predefined portion of main memory region 163 may store a copy of an operating system used by processor 101. During a restart of computer system 100, all or parts of the operating system are quickly loaded through memory controller 120 into direct memory region 151.

In a power saving embodiment, perhaps when computer system 100 is relatively idle, some or all of direct memory region 151 may be copied to main memory region 163, with SDRAMs that had held the copied portions of direct memory region 151 powered down (e.g., placed in “deep sleep”, or similar, mode, subsequent to the copying). Address mapper 124 and associated configuration registers 123 must be updated such that accesses to such copied data are served from main memory region 163, rather than direct memory region 151. In an extreme example, in which direct memory region 151 contains zero bytes, portion start 181C and portion end 182C (FIG. 6) are set to the same value; convert real to physical 122 is updated to recognize that the data then resides in main memory region 163, not direct memory region 151, and subsequent requests are then serviced from main memory region 163, via cache region 152.

In an embodiment, an operating system running in processor 101 is aware of particular types of data that may be required for a fast startup (“boot”) of processor 101. For example, a hypervisor and the operating system itself may be identified for storage in main memory region 163. Further, such types of data are typically very frequently used during operation of processor 101, and may be “pinned” in cache region 152, for example, by setting one or more state bits in state bits 201, or, alternatively, as one or more bits in storage type 202 (FIG. 7). Multiple bits may be used in storage type 202 to indicate a degree of pinning. For example, suppose storage type 202 contains two bits. A “00” may indicate that no pinning is needed. A “01” may indicate a mild degree of pinning requirement, perhaps for a portion of the operating system that is infrequently used. A “10” may indicate a relatively high degree of pinning requirement, perhaps for a moderately used portion of the operating system. An “11” may indicate a very high degree of pinning requirement, such that the data always remains in cache region 152.

Memory controller 120 uses address mapper 124 and values in configuration registers 123 as described earlier to store data in direct memory region 151 or in main memory region 163. A software application (operating system, hypervisor, user program) running in processor 101 may want to know where data is stored. The software may then be able to leverage this information for future runs of the software. In an embodiment of the invention, location information (i.e., direct memory region 151 or main memory region 163) may be transmitted from memory controller 120 to processor 101 via processor bus 130. Address mapper 124 determines location information on every read (and write) request made by processor 101.

In an embodiment of the invention, location information is transmitted to processor 101 upon a request by processor 101. For example, processor 101 sends a write request to memory controller 120, followed by a location information request also sent on processor bus 130. In response, memory controller 120 transmits the location information to processor 101. In an exemplary embodiment, two bits are used for location information; “00” may mean that the address in the immediately previous memory request (read or write) mapped to direct memory region 151; “01” may mean that the address in the immediately previous address request mapped to a first main memory region, such as main memory region 163A, FIG. 6); “10” may bean that the address in the immediately previous address request mapped to a second main memory region such as main memory region 1638, FIG. 6); and so on. The software then knows what type of storage was used for the data that was written (or read).

In an embodiment of the invention, additional lanes in processor bus 130 may be used to transmit location information from memory controller 120 to processor 101 on every memory request. In the example of the previous paragraph, two additional lanes would be required.

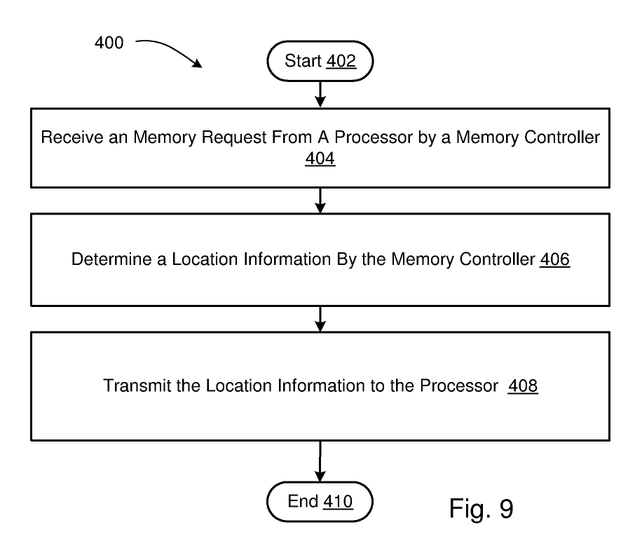

Method 400, FIG. 9, shows, at a high level, location information as described above being made available to a processor 101 for use by software. Method 400 begins at block 402. In 404, memory controller 120 receives a memory request (read or write) from processor 101. In block 406, memory controller 120 (address mapper 124) determines where an address associated with the memory request is directed, that is, as explained above, to direct memory region 151 or to main memory region 163. In block 408, the location information is transmitted to processor 101, for examples as described above, upon explicit request, or automatically for every memory request. Block 410 ends method 400.

The operating system (OS) program allocates and distributes memory to itself and user application programs and processes. A combined memory 170 (FIG. 4) comprising multiple regions (e.g., direct memory region 151 and main memory region 163) may have differing characteristics, such as power, access bandwidth, access latency, non-volatility, cacheability and cache replacement policy. These memory region characteristics can be defined to the OS program through a memory map table data structure such that the OS advantageously optimizes system and program runtime priority, real-time quality of service, reliability, performance and system power efficiency through memory allocation and distribution to itself and user application programs and processes.

In embodiments of the invention, the OS/user program environment uses “virtual” addresses, which are translated to real addresses transmitted by processor 101 to memory controller 120. Techniques are available for using the virtual address space to configure memory access to various physical locations by appropriate translation to real addresses. For example, U.S. Pat. No. 7,539,842, “Computer memory system for selecting memory buses according to physical memory organization information stored in virtual address translation tables”, assigned to the assignee of the current patent, teaches of systems and methods for program directed memory access patterns including a memory system with a memory, a memory controller and a virtual memory management system. The virtual memory management system includes: a plurality of page table entries for mapping virtual memory addresses to real addresses in the memory; a hint state responsive to application access information for indicating how real memory for associated pages is to be physically organized within the memory; and a means for conveying the hint state to the memory controller.

In an embodiment of the present invention, an operating system (OS) running in processor 101 provides values in configuration registers 123 that control what real addresses map to direct memory region 151 and what real addresses map to main memory region 163; therefore, the operating system “knows” what ranges of real addresses map to what kind of storage (e.g., direct memory region 151 and main storage region 163) and can therefore can map various virtual addresses to real addresses in the desired type of storage using the teachings of U.S. Pat. No. 7,539,842. For example, a frequently-used portion of the OS having a range of virtual address space would have information set in the virtual address translation tables to map these virtual addresses to direct memory region 151. A vast database with known highly random addressing pattern may have a virtual address range directed to main memory region 163 through information set in the virtual address translation tables. However, a database program itself (as opposed to the vast database accessed by the database program) may have very heavy access, and the database program may inform the operating system to store information in the virtual address translation tables associated with virtual addresses of the database program such that the real addresses provided by the translation are mapped to direct memory region 151.

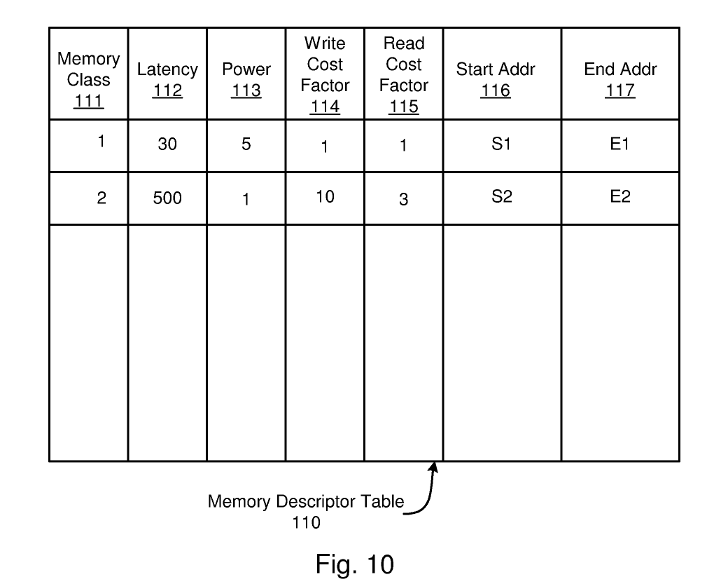

In an embodiment, processor 101 comprises memory descriptor table 110 which contains information regarding different types of memory available. In FIG. 10, an exemplary memory descriptor table 110 is shown. Memory descriptor table 110 may comprise data needed to describe various types of memory. For example, a memory class 111 (which may be alternatively simply be implied by a row number in embodiments).

Latency 112 describes typical latencies of various types of memory. For example, if memory class “1” is for direct memory region 151, typical latency may be 30, as shown. “30”, of course, may be a value indicating an actual number of time units, such as 30 nanoseconds, or simply a number relative to other types of memory. If memory class “2” is for main memory region 163, and main memory region 163 is implemented in flash memory, a significantly higher value is placed in the corresponding row/column; “500” is shown for exemplary purposes. Flash memory is considerably slower than SDRAM memory as is typically used in direct memory 151; furthermore, a cache block or at least a portion of a cache block containing the desired data must be transmitted from IO Controller 161.

Values stored in power 113 column indicate typical power for the particular memory class. Power may be in actual watts per megabyte (MB), or, like values in the latency 112 column, may be relative. In the example given in FIG. 10, when the memory class is “1”, the corresponding power is “5”; when the memory class is “2”, the corresponding power is “1”. Typically, power per given amount of memory in main memory region 163 is much less than for the same given amount of memory in direct memory region 151.

Write cost factor 114 contains values, for each memory class, of a relative cost to write data. The write cost may be used to modify latency (e.g., flash memory takes a long time and may modify the latency value), or the write cost may be used to indicate that some memory types are subject to wear out mechanisms. Flash memory, for example, tends to “wear out” after a number of writes, typically in the hundreds of thousands of writes, whereas SDRAM memories may be written almost indefinitely without wear out being a consideration.

Read cost factor 115 is similar to write cost factor 114, but for reads, rather than writes.

Start Address 116 and end address 117 contain values (shown as S1, E1, S2, E2) to indicate real starting address and real ending address for each memory class defined in memory class 111 column. In an embodiment, these values are transmitted to memory controller 120 for storage in configuration registers 123. See further details as to starting and ending addresses in FIG. 6.

With the characteristics associated with each memory class defined as described above and therefore known to the OS, the OS has to know when to allocate storage to one memory class versus a second memory class.

In a first embodiment, an application may declare a memory class to the OS. A user (or programmer) may provide memory class information with his or her program to tell (e.g., through a compiler) what class of memory would be appropriate. In the previous example of the vast database and associated program, the programmer may provide guidance to the OS that the database itself should be stored in memory class “2” (in the example, main memory region 163) but that the database program should be stored in memory class “1” (in the example, direct memory region 151). In embodiments, the OS also maps high priority applications such as graphics, interrupt and real-time service, in memory class “1”.

In a second embodiment, dynamic optimization of memory into memory classes is performed. For example, a process ID associated with a particular application is forwarded to memory controller 120 with an access request. Memory controller 120 employs hardware counters (e.g., registers or SRAM (static random access memory) locations) (not shown) to count a reference rate to a specific memory class associate with the process ID. The OS (or hypervisor) may monitor these counters, using special requests to memory controller 120, to determine if the memory class is optimal or appropriate. For example, a high cache miss rate, according to predetermined thresholds, to a slow memory, such as main memory region 163, would cause the OS to manage a table of memory allocation “exceptions”, and the OS may then pin the addresses in the cache or change the memory class for data associated with the process ID (e.g., change the memory class from “2” to “1” in the example above, with physical movement of storage associated with the process ID from main memory region 163 to direct memory region 151). The OS may determine that a specific process ID rarely runs and can be similarly re-mapped or allocated from memory class “1” to memory class “2”. The OS may further use the values in the write cost factor 114 column and the read cost factor 115 column to determine an appropriate memory class for a particular process ID. For example, if the particular process ID makes very frequent (relative to a prespecified threshold) write accesses, the OS may more quickly change memory class for that process ID than if a relatively frequent number of read accesses are performed. In the exemplary memory descriptor table 110, memory class 2 is shown to have a write cost factor of 10, versus a read cost factor of 3. In an embodiment of the invention, values in the power 113 column may be changed for different time periods. For example, if power usage in a data center having computer system 100 is approaching a predetermined threshold, relative power values may be changed, for example, the value for the power 113 column for memory class 1 may be raised from “5” to “10”, to discourage allocation of memory in memory class 1.

In yet another embodiment of the invention, the OS allocates a “cheapest” (e.g., lowest power memory) memory by default or until the lowest cost memory is exhausted, and then allocating to a next cheapest memory. Of course, having thusly allocated memory, memory associated with process IDs may be performed as described above, so that frequently used memory may be moved to more “costly” (e.g., higher power) memory.

Measurements or access pattern data associated with regions of memory or process ID may be stored, along with the process ID, on a hard disk, in a directory (not shown) in memory controller 120; in a special area (not shown) reserved for memory controller 120 in main memory 150; in unused (non-allocated) areas in main memory 150; or other memory accessible to memory controller 120.

Embodiments of the invention may be expressed as methods.

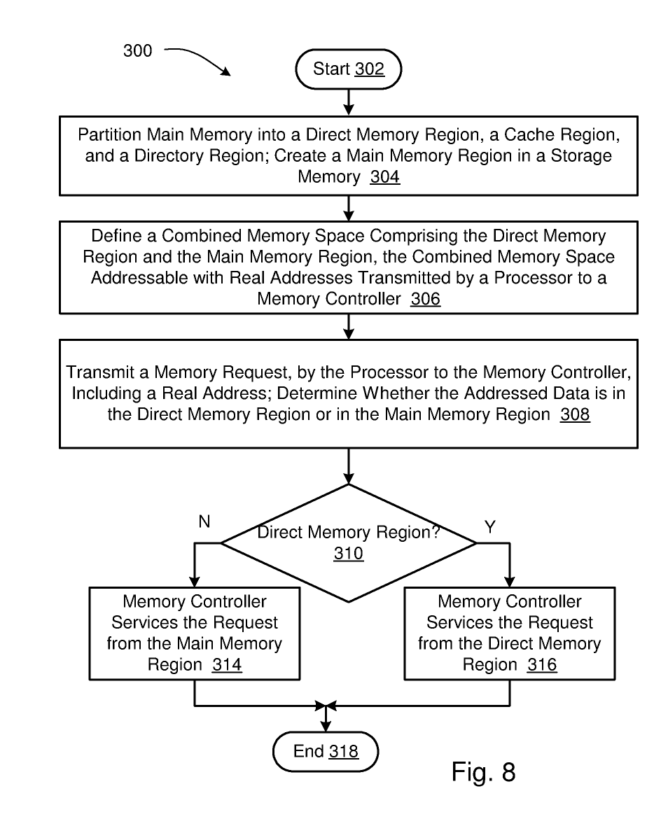

FIG. 8 shows a flow chart of a method 300 embodiment of the invention. Method 300 begins at block 302. In block 304, main memory (such as main memory 150 in FIG. 1) is partitioned into a direct memory region (such as direct memory region 151 in FIG. 1); a cache region (such as cache region 152 in FIG. 1); and a directory region (such as directory region 153 of FIG. 1). A main memory region (main memory region 163, FIG. 1) is created in a storage memory. Bounds of the direct memory region, the cache region, and the directory region may be programmable, as well as size of cache blocks used in the cache region, as described earlier with reference to FIG. 6.

In block 306, the direct memory region described above is combined with a main memory region in a storage memory to form a combined memory, such as is shown in FIG. 4 and described earlier. Main memory region 163 is implemented with memory technology, such as flash, MRAM or FeRAM as described above that is dense, cheap, and low power, relative to memory technology used to implement main memory 150. In some embodiments, main memory region 163 is implemented with non-volatile memory technology, such as flash, MRAM or FeRAM. Bounds of one or more main memory region(s) may be programmable as described earlier with reference to FIG. 6.

In block 308, the processor transmits a memory request to the memory controller, including a real address. An address mapper (such as address mapper 124, FIG. 1) determines if the address is in the direct memory region or in the main memory region in the storage memory.

If the address is determined to be in the direct memory region, the memory controller services the memory request in a conventional manner from the direct memory region in block 316.

If the address is determined to be in the main memory region in the storage memory, block 314 is executed; the memory controller determines if the address is in the cache region by querying the directory region. If the address is in the cache region, the memory request is serviced from a cache block in the cache region that contains the address. If the address is not in the cache region, a storage access controller (storage access controller 126) forms and transmits a request to an IO controller (IO controller 161, FIG. 1) using DMA or other protocol suitable for communicating with IO controller 161 to transmit a cache block having the addressed data. A cache controller (cache controller 125, FIG. 1) manages coherency of the cache, using state bits in a cache directory entry. During reception of the cache block from IO controller 120, shadow buffers (such as shadow buffers 127, FIG. 1) may be used to temporarily buffer a cache directory entry for the cache block. Upon completion of transmission, the temporary cache directory entry in the shadow buffers may be copied to the directory region. Use of the shadow buffers reduces possible frequent updating of the directory entry while the cache block is being received. The cache block may be relatively large (perhaps 8 KB or larger) and a significant amount of time may therefore elapse during transmission of the cache block. Upon reception of data at the address request, the data is transmitted to the processor, even if the entire cache block has not been received. If the memory request was for a “write”; data in the cache may be written when the proper portion of the cache block has been received, and appropriate status bits in the directory entry in the shadow buffers are updated. If shadow buffers are not used, the appropriate status bits in the directory region are updated.

Block 318 ends method 300.

What is claimed is:

1. A computer system comprising:
a combined memory further comprising;
a storage memory comprising a main memory region that is a first logical partition of the combined memory; and
a main memory comprising a direct memory region that is a second logical partition of the combined memory; and
a memory controller comprising a storage controller configured to access main memory region and the main memory.

2. The computer system of claim 1, the memory controller further comprising a cache controller coupled to a cache for caching data stored in the main memory region, the cache further comprising a cache region for storing cache blocks, and a directory region for storing directory entries associated with the cache blocks.

3. The computer system of claim 2, the main memory further comprising the cache region.

4. The computer system of claim 2, wherein a size of the cache blocks is programmable.

5. The computer system of claim 2 wherein a size of the cache region is programmable.

6. The computer system of claim 2, the main memory further comprising the directory region.

7. The computer system of claim 2, the memory controller further comprising the directory region.

8. The computer system of claim 2, the directory entries further comprising state bits that include one or more bits to indicate block sector modified.

9. The computer system of claim 2, the directory entries further comprising state bits that include one or more bits to indicate replacement weighting.

8. The computer system of claim 1 wherein the main memory region is implemented in non-volatile memory technology.

9. The computer system of claim 8, wherein information required for a fast start is stored in the main memory region.

10. The computer system of claim 1, the storage controller configured to access the main memory region using a direct memory access (DMA) protocol.

11. The computer system of claim 1, the memory controller further comprising an address mapper to determine if an address received by the memory controller is in the direct memory region or in the main memory region.

12. The computer system of claim 1, the main memory region further comprising a third logical partition of the combined memory.

13. The computer system of claim 1, further comprising a software system that transmits information associated with a particular data to the memory controller to assist the memory controller in storing the particular data in the direct memory region or in the main memory region.

14. The computer system of claim 13, wherein the information associated with the particular data is further used by the memory controller to influence a cache block replacement algorithm used by the memory controller.

15. The computer system of claim 1 wherein a location information is transmitted to the processor by the memory controller, the location information indicating whether a particular memory access maps to the main memory region or to the direct memory region.

16. The computer system of claim 15, wherein the location information is transmitted to the processor by the memory controller respondent to a request by the processor for the location information.

17. The computer system of claim 15, wherein the location information is transmitted to the processor by the memory controller without a request by the processor for the location information.

18. A method for providing a tiered memory system in a computer comprising:
creating a combined memory space comprising a direct memory region as a first logical partition of the combined memory and a main memory region in a storage memory as a second logical partition of the combined memory;
accessing data in the direct memory region with a memory controller; and
accessing data in the main memory region in the storage memory with the memory controller.

19. The method of claim 18, further comprising:
partitioning a main memory into the direct memory region, a cache region, and a directory region.

20. The method of claim 19, wherein the partitioning includes programmably partitioning the size of the direct memory region.

21. The method of claim 19 wherein a cache block size is programmable.

22. The method of claim 19 wherein accessing data in the main memory region in the storage memory further comprises:
transmitting an access by the memory controller to the storage memory in a protocol suitable for the storage memory;
receiving a cache block from the main memory region into the cache region;
updating a directory entry in the directory region associated with the cache block; and
transmitting a segment of the cache block from the memory controller to a processor.

23. The method of claim 22 wherein updating the directory entry in the directory region further comprises:
updating a shadow buffer copy of the directory entry during at least a portion of the transmission of the cache block; and
when the cache block transmission is complete, copying the shadow buffer copy of the directory entry into the directory region.

24. The method of claim 18, further comprising providing one or more memory classes available to an operating system to allocate memory.

25. The method of claim 24, further comprising providing a mechanism by which the operating system knows what virtual addresses will be mapped to each of the one or more memory classes.

26. The method of claim 25, further comprising declaring to an operating system by an application program a particular memory class appropriate for the application program.

27. The method of claim 25, further comprising learning, by the operating system, an appropriate memory class for a particular process ID

28. The method of claim 25, further comprising:
allocating, by the operating system, memory to a lowest-cost class of memory until the cheapest memory is exhausted, and then allocating memory to a next-lowest-cost class of memory.

29. The method of claim 28, wherein the cost of each memory class is determined by power for a given amount of memory.
